(19) United States
(12) Patent Application Publication
(10) Pub. No.: US 2018/0189365 A1
(43) Pub. Date: Jul. 5, 2018

(54) COMBINING MANUAL AND AUTOMATED TEST RESULTS IN AN INDUSTRIAL FACILITY

(71) Applicant: HONEYWELL INTERNATIONAL INC., MORRIS PLAINS, NJ (US)

(72) Inventors: ANTOINE GUILLOT, DOYLESTOWN, PA (US); MICHAEL JAMES WAYNICK, HATBORO, PA (US); YONG YANG, SHANGHAI (CN)

(21) Appl. No.: 15/398,431

(22) Filed: Jan. 4, 2017

(51) Int. Cl. G06F 17/30; G05B 23/02

(52) U.S. Cl. CPC G06F 17/30563; G05B 23/0208; G06F 17/30377; G06F 17/30339

(57) ABSTRACT

A method of combining test results from devices including processing equipment and field devices in an integrated industrial control system (IICS) of an industrial facility (IF). The method includes entering manual test data obtained from at least a first device into a first electronic data file in a memory associated with a computer-based testing tool including a processor. The computer-based testing tool initiates at least partially automatic testing and automatic collection to obtain at least partially automatic test data involving the first device. The manual test data and the at least partially automatic test data are automatically combined in the first electronic data file to provide a combined overall test result for the first device.

### FIELD

Disclosed embodiments relate to industrial control systems, and more specifically to combining test results in an industrial facility.

### BACKGROUND

Processing facilities (or industrial facilities) are often managed using process control systems also known as control and instrumentation (C&I) systems. Processing facilities can include manufacturing plants, chemical plants, crude oil refineries, ore processing plants, and paper or pulp manufacturing plants referred to herein as an integrated industrial control system (IICS). These industries typically use continuous processes and fluid processing. The control system(s) typically manage the use of motors, valves, sensors, gauges and other industrial equipment in the processing facilities. A manufacturing plant or refinery may use one or more distributed control systems (DCS), programmable logic controls (PLC), safety system and applications for controlling different processes.

During commissioning and testing of an IICS many tests are conducted that need to be kept track of and ultimately signed-off by a user after their successful completion. The physical and logical/configuration validation performed on a piece of equipment, e.g. a device to be commissioned in a plant, can be split and executed at different times, different locations, and by different testers. However, all of the test results generally need to be combined into a single common electronic data file (or record) to make the sign-off process more efficient.

### SUMMARY

This Summary is provided to introduce a brief selection of disclosed concepts in a simplified form that are further described below in the Detailed Description including the drawings provided. This Summary is not intended to limit the claimed subject matter's scope.

Disclosed embodiments recognize that managing hundreds, if not thousands of tests performed devices including processing equipment and field devices in an IICS can be a challenging task further complicated by the fact that tests may sometimes be manually performed while other tests may be fully automated or partially automated. Test that can't be performed in an automated manner need to be performed manually. This is a major problem because a process engineer or other user will need to review and manually combine the results of each of the manual, semi-automated and automated tests in order to diagnose problems and correct errors within the industrial facility (IF), such as a plant or refinery. Another problem is that the various tests within the IF utilize different test procedures, test methods (e.g. manual, semi-automated and automated methods), and test applications (programs that automate testing) to conduct the various test procedures or operations. The test data needed by the process engineer to diagnose problems and correct errors is generally in a plurality of separate data repositories (memories).

Disclosed embodiments solve the problem of having manual, semi-automated and automated test results in separate electronic data files which is generally in separate data repositories in an IICS by providing a method, a system and a computer program product that combines test results from devices including processing equipment and field devices into a single (common) electronic data file (or document) in a selected electronic repository (memory). The electronic data file may be spreadsheet-based comprising a single spreadsheet workbook including multiple worksheets or for a database embodiment a combined data table comprising multiple data tables. An electronic repository (memory) as used herein refers to a place (location) in the IF where data including test data is stored and maintained.

Disclosed embodiments thus allow test results to be grouped together in a logical manner in a single electronic data file, which thus can be efficiently reviewed by a user selecting, via a single command, to view the single (common) electronic data file that contains the combined test results. By combining all the test results into a single electronic data file, an overall test result can be presented to the user that improves efficiency in managing the progress and ultimate successful completion of the testing and sign-off process.

Disclosed embodiments include a method of combining test results from devices including processing equipment and field devices in an IICS of an IF. The method includes entering manual test data obtained from at least a first of the devices into a first electronic data file in a memory associated with a computer-based testing tool including a processor. The computer-based testing tool initiates at least partially automatic testing and automatic collection to obtain at least partially automatic test data involving the first device. The manual test data and the at least partially automatic test data are automatically combined in the first electronic data file (e.g., into a single workbook) to provide a combined overall test result for the first device. Thus despite the test data being from various sources, applications, and programs for automated and/or semi-automated tests and from users for manual test entered interactively, a single electronic data file is generated that provides a combined overall test result.

Disclosed embodiments further include a system for combining test results from devices including processing equipment and field devices in an IICS of IF. The system includes an IICS computer that is communicatively coupled by a communication network to the devices. The IICS computer includes a first processor connected to a first memory device having a first non-transitory machine-readable storage medium storing a computer-based testing tool. The IICS computer is programmed to implement the computer-based testing tool causing the IICS computer to allow entering manual test data obtained from at least a first of the devices into a first electronic data file in the memory device and to initiate at least partially automatic testing and automatic collection to obtain at least partially automatic test data involving the first device. The manual test data and the at least partially automatic test data are automatically combined in the first electronic data file to provide a combined overall test result for the first device.

### BRIEF DESCRIPTION OF THE DRAWINGS

FIG. 1 is a diagrammatic view of hardware and software components in an IICS including an IICS computer and subsystems for combining test results, according to an example embodiment.

FIG. 2A illustrates contents of configuration and test repository (CTR) data, according to an example embodiment.

FIG. 2B illustrates contents of another embodiment of CTR data, according to an example embodiment.

FIG. 3 is a diagrammatic view of hardware and software components and workflows in an IICS for combining test results, according to an example embodiment.

FIGS. 4A and 4B are a flow chart that shows steps in an example method of combining test results in an IICS, according to an example embodiment.

FIG. 5 illustrates an example screenshot of a test workbook, according to an example embodiment.

FIGS. 6A and 6B together represent an example screenshot of a test parameter worksheet, according to an example embodiment.

### DETAILED DESCRIPTION

Disclosed embodiments are described with reference to the attached figures, wherein like reference numerals are used throughout the figures to designate similar or equivalent elements. The figures are not drawn to scale and they are provided merely to illustrate certain disclosed aspects. Several disclosed aspects are described below with reference to example applications for illustration. It should be understood that numerous specific details, relationships, and methods are set forth to provide a full understanding of the disclosed embodiments.

One having ordinary skill in the relevant art, however, will readily recognize that the subject matter disclosed herein can be practiced without one or more of the specific details or with other methods. In other instances, well-known structures or operations are not shown in detail to avoid obscuring certain aspects. This Disclosure is not limited by the illustrated ordering of acts or events, as some acts may occur in different orders and/or concurrently with other acts or events. Furthermore, not all illustrated acts or events are required to implement a methodology in accordance with the embodiments disclosed herein.

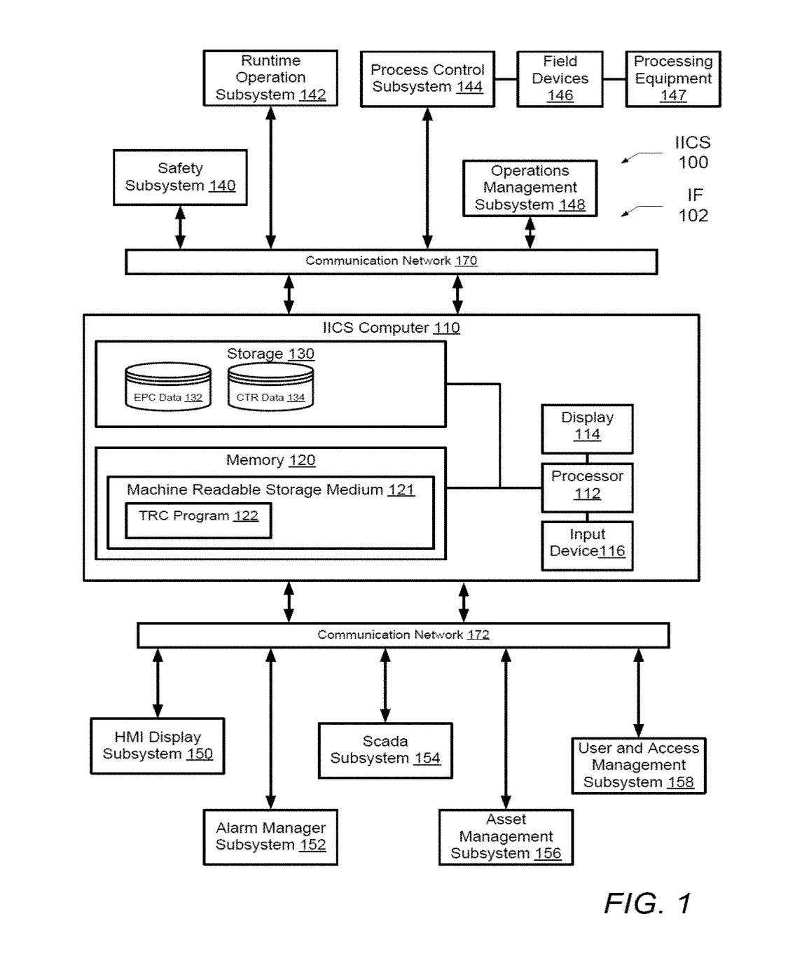

Disclosed embodiments provide a method, system and computer program product for automatically combining test results in an IICS from various sources, applications, and programs for automated and/or semi-automated tests and from users for manual test entered interactively into a single data file. FIG. 1 shows an example IICS 100 that combines such test results into a single electronic data file referred to herein as a first electronic data file stored in an electronic repository (e.g., a persistent memory) of an IF 102. IICS 100 comprises the blocks shown in FIG. 1 including IICS computer 110 and a plurality of subsystems 140, 142, 144, 148, 150, 152, 154, 156 and 158. IICS computer 110 includes a processor 112 that is coupled to a memory device or memory 120, a storage device or storage 130 such as a hard drive, a video display 114, and an input device 116 such as a keyboard and mouse. Memory 120 includes a non-transitory machine readable storage medium 121 that stores a computer-based testing tool also referred to as a test result compilation (TRC) program 122.

TRC program 122 executing on processor 112 can combine test results from multiple tests including manual, semi-automated and automated tests run on subsystems 140-158 into a first electronic data file. TRC program 122 executing on processor 112 efficiently collects data from various sources into a common first electronic data file such as a single workbook or a single combined table in a database. As used herein “manual test data” refers to data representing or associated with tests requiring user (human) interaction. These can be a simple test result or data recorded while an engineer or technician takes some actions directly or indirectly that cannot be automated. As used herein “semi-automated test data” refers to data representing or associated with tests that are partially automated requiring some limited user interaction, such as to trigger as well as control the execution of automated steps. As used herein “automated test data” refers to data representing or associated with tests that are fully automated and require no user interaction once initiated.

IICS computer 110 is communicatively coupled to communication network 170 and communication network 172. Communication networks 170 and 172 can be a wide variety of wireless or wired communication networks such as Ethernet, fault tolerant Ethernet (FTE), a Local Control Network (LCN), a wireless network, a wide area network (WAN) or the Internet. Storage 130 can store engineering, procurement and construction (EPC) data 132 and CTR data 134.

As known in the art, a database stores data values in tables. Each table has a name and one or more columns and rows. A row in a table is generally called a record. A single record includes a value for each column in a table. Databases can enforce relationships between records in different tables.

The subsystems shown include safety subsystem 140, runtime operation subsystem 142, process control subsystem 144 and operations management subsystem 148, which are communicatively coupled to communication network 170. One or more field devices 146 are coupled to sense parameters from processing equipment 147 that are communicatively coupled to process control subsystem 144. Field devices 146 can be a wide variety of sensors (including smart sensors) or meters, alarms, valves, or actuators, and the processing equipment 147 can comprise mixers, burners, pumps, and motors. The subsystems shown also include human machine interface (HMI) display subsystem 150, alarm manager subsystem 152, Supervisory control and data acquisition (SCADA) subsystem 154, asset management subsystem 156 and user and access management subsystem 158, which are communicatively coupled to communication network 172. IICS computer 110 can communicate with each of the subsystems via communication networks 170 and 172.

While TRC program 122 is shown executing on processor 112 of IICS computer 110, TRC program 122 can reside and be executed from other outside applications (3rd party applications) via other computers that are in the communication network of IICS 100. The outside applications can incorporate TRC program 122 to perform tests, generate test results and combine test results collected from various manual, semi-automated or automated tests.

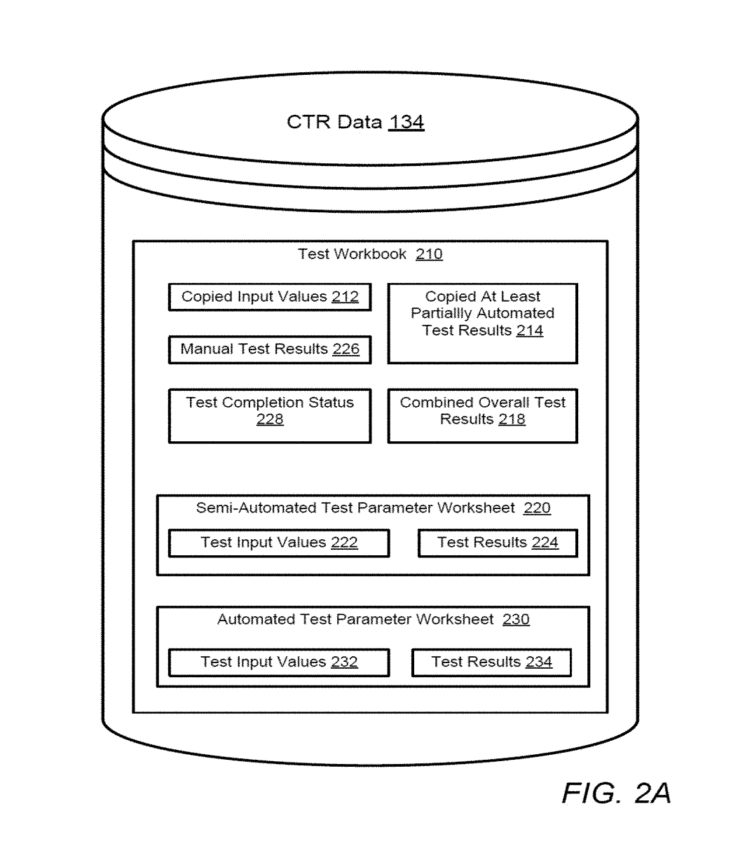

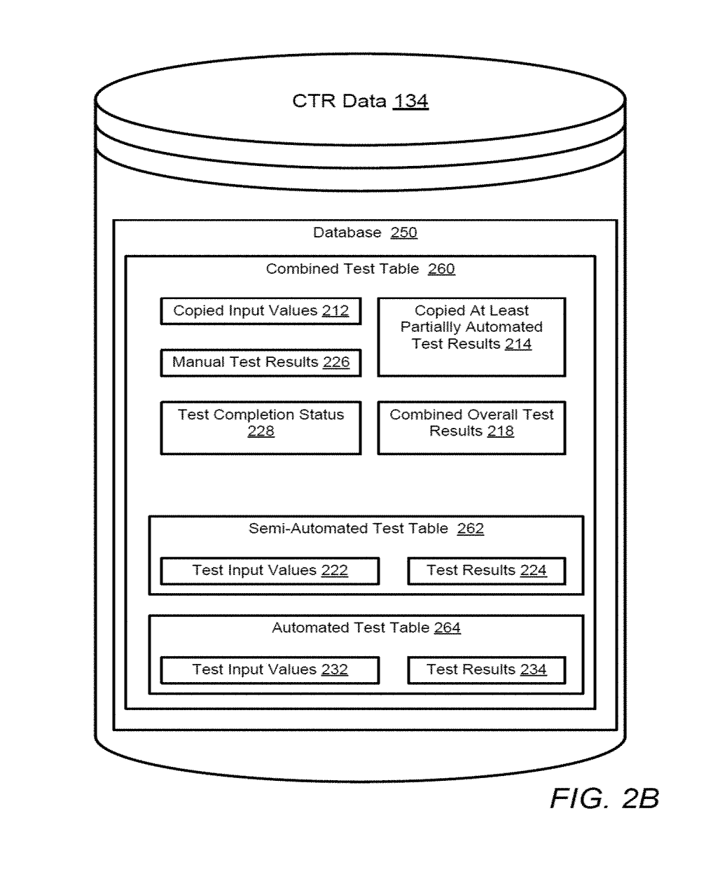

FIG. 2A illustrates contents of CTR data 134. CTR data 134 can include in the case of a spreadsheet embodiment a test workbook 210 that comprises semi-automated test parameter worksheet 220 and automated test parameter worksheet 230. Test workbook 210 can includes tens or hundreds of worksheets. Test workbook 210 further includes copied input values 212, copied at least partially automated test results 214, manual test results 226, combined overall test results 218, and test completion status 228. In one embodiment, combined overall test results 218 can be an independent worksheet of test workbook 210. Test workbook 210 is the single electronic data file or document where all of the test results from manual, semi-automated and fully automated tests are combined. Further, semi-automated and automated tests can be triggered, called, invoked and executed by a process engineer from the test workbook 210 via linked calls.

Manual test results 226 can be directly entered into test workbook 210 by a process engineer or other user via input device 116. In one embodiment, the semi-automated test parameter worksheet 220 and automated test parameter worksheet 230 of test workbook 210 can utilize a document technology such as Microsoft EXCEL, WORD or any other application capable of visualizing text and images or other visual components presented in documents. The test workbook 210 can serve as both a user interface data entry mechanism to record manual test results and a repository for the manual, semi-automated and automated test data and results.

In one embodiment, the test workbook 210 can be stored in a table of a structured query language (SQL) database. The combining of the test results is achieved by letting users define the format of the workbook where manually entered test results are located in a worksheet and test results that were collected programmatically by automated or semi-automated tests are located in another worksheet. Manual test results are entered interactively by users while other test results are entered in their worksheet (220 or 230) when automated tests are executed. How the automated test results get to the worksheet in the right location is defined by the various worksheets in the test workbook 210 and linked cells to ‘collect’ the results in the right place and format.

Semi-automated test parameter worksheet 220 includes test input values 222 and test results 224. Automated test parameter worksheet 230 includes test input values 232 and test results 234. While two test parameter worksheets 220 and 230 are shown, it is understood that the workbook 210 can have more test parameter worksheets. Test parameter worksheets 220 and 230 can contain user customizable test parameters, associated variables and objects and calculated fields. Various cells of test workbook 210 can be linked to cells of test parameter worksheets 220 and 230 in order to collect and pass test input values, test parameters, test objects, test variables and test results between test workbook 210 and test parameter worksheets 220 and 230.

For example, listed below is a top level EXCEL macro invoke that executes all of the automated tests defined in a particular workbook. ‘ Execute all automated/assisted tests referenced in a given Loopcheck/User test workbook.’ ‘ wbName: Name of Loopcheck/User test workbook’

FIG. 2B illustrates another embodiment of the contents of CTR data 134. CTR data 134 can include a database 250. Database 250 is a structured collection of information that is organized so that it can easily be accessed, managed, and updated. Database 250 can include a combined test table 260 that comprises semi-automated test table 262 and automated test table 264. Combined test table 260 can include tens or hundreds of tables. Combined test table 260 further comprises copied input values 212, copied at least partially automated test results 214, manual test results 226, combined overall test results 218 and test completion status 228. In one embodiment, combined overall test results 218 can be an independent test table of combined test table 260. Combined test table 260 is the single electronic data file or document where all of the test results from manual, semi-automated and fully automated tests are combined. Further, semi-automated and automated tests can be triggered, called, invoked and executed by a process engineer from the combined test table 260.

Manual test results 226 can be directly entered into combined test table 260 by a process engineer or other user via input device 116. In an embodiment, the semi-automated test table 262 and automated test table 264 of combined test table 260 can utilize a database document technology such as Microsoft ACCESS or VISIO, or any other database application. The database can serve as both a user interface data entry mechanism to record manual test results and a repository for the manual, semi-automated and automated test data and results. Other types of applications can also be used. Document technologies such as MS ACCESS or VISIO have the ability to maintain data and provide a view to present it to a user along with script support to run automated or semi-automated tests and generate test results.

As known in the art, each of the tables 260, 262 and 264 has columns and rows, wherein each row in the table is called a record. A single record includes a value for each column in a table. The database 250 enforces relationships between the records in different tables.

Semi-automated test table 262 includes test input values 222 and test results 224. Automated test table 264 includes test input values 232 and test results 234. While two test tables 262 and 264 are shown, it is understood that combined test table 260 can more than 2 test tables. Test tables 262 and 264 can contain user customizable test parameters, associated variables and objects and calculated fields. Various records of combined test table 260 can be linked to records of test tables 262 and 264 in order to collect and pass test input values, test parameters, test objects, test variables and test results between combined test table 260 and test tables 262 and 264.

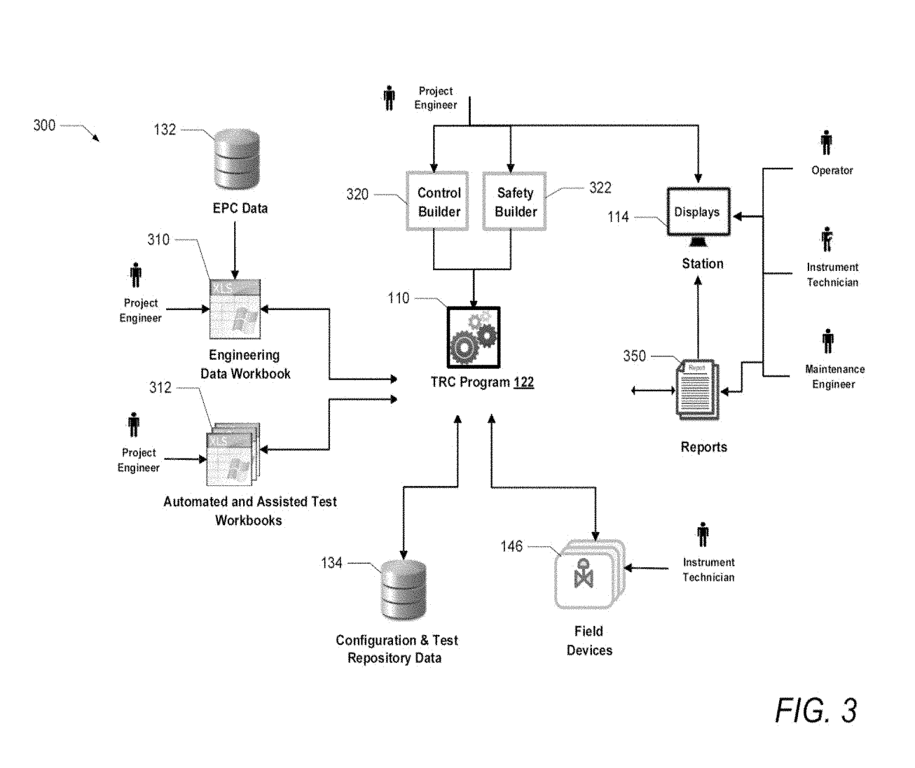

FIG. 3 illustrates a diagram 300 of hardware and software components and workflows within IICS 100. Engineering, procurement and construction (EPC) data 132 stores engineering data workbooks 310 for spreadsheet applications and combined tables for database applications that contain engineering and configuration information for IF 102. A project engineer can input data into a worksheet of the engineering data workbooks 310. Automated and assisted test workbooks 312 can include test workbook 210. Automated and assisted test workbooks 312 is where tests are defined, run and where test results (manual, automated or semi-automated) are combined and recorded via TRC program 122 executing on IICS computer 110.

A project engineer can run manual tests and input manual data and test results into automated and assisted test workbooks 312. IICS computer 110 is in communication with CTR data 134 and field devices 146. IICS computer 110 is further in communication with control builder system 320 and safety builder system 322. TRC program 122 can generate reports 350 based on automated and assisted test workbooks 312 for display on video display 114. The reports 350 can be viewed by operators, instrument technicians, and maintenance engineers.

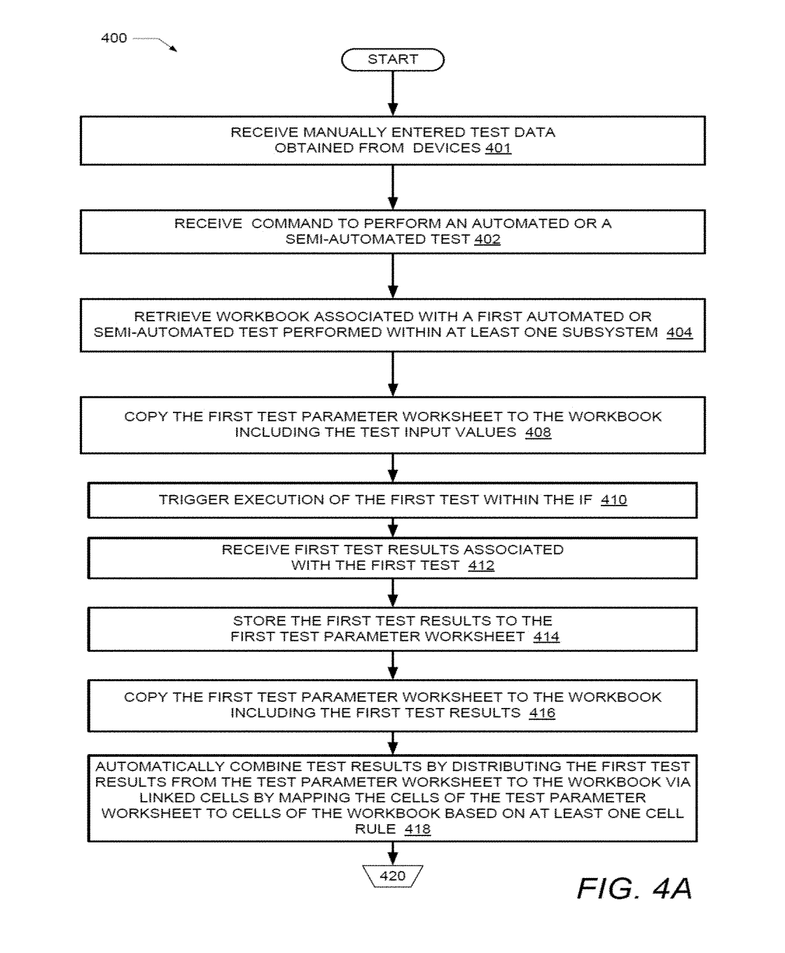

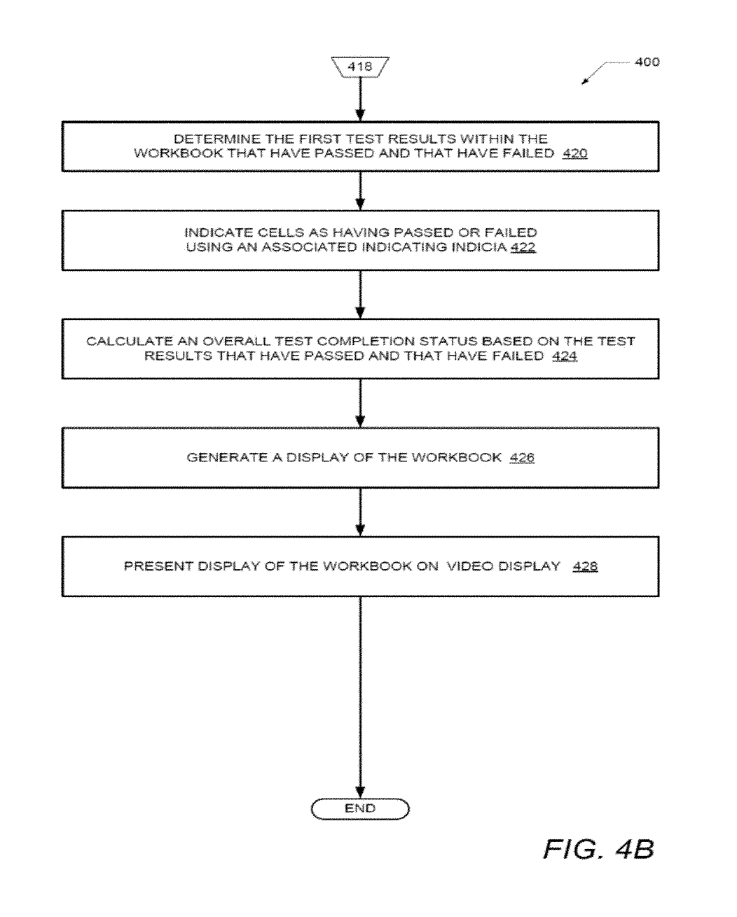

FIGS. 4A and 4B are a flow chart showing steps in an example method 400 for combining test results from devices including processing equipment 147 and field devices 146 in an IICS 100 of IF 102. With reference to FIGS. 1-4B, method 400 can be implemented via the execution of TRC program 122 by processor 112. While method 400 is illustrated using electronic data files having a spreadsheet document technology, (i.e. test workbook 210) it is understood that method 400 can also be implemented using electronic data files having other document technologies such as databases (i.e. combined test table 260)

Method 400 begins at the start block and proceeds to block 401. At block 401, processor 112 receives manually entered manual test data such as manual test results 226 obtained from one or more of process equipment and field devices 146. A user can input manual test results 226 via input device 116. Processor 112 receives a command to perform an automated or semi-automated first test (block 402). In another embodiment, the command can be automatically initiated by the computer based testing tool. Processor 112 retrieves an electronic data file such as test workbook 210 associated with a first automated or semi-automated test of the process equipment and field devices 146 (block 404). Test workbook 210 includes a first test parameter worksheet (i.e. semi-automated test parameter worksheet 220 or automated test parameter worksheet 230) associated with the first test including the test input values (i.e. test input values 222 or 232).

Processor 112 copies the first test parameter worksheet 220 or 230 including the test input values to the test workbook 210 as copied input values 212 (block 408). Processor 112 triggers the the first test to be executed on process equipment and field devices 146 using at least one of the test input values for the first test (block 410). In one embodiment, the first test within is triggered via at least one button of the test workbook 210. The button invokes a first call to a subroutine of the TRC program 122 that causes the first test to be executed.

At block 412, processor 112 receives the at least partially automatic test data or test results (i.e. test results 224 or 234) from the first test and stores the at least partially automatic test data to the first test parameter worksheet (i.e. semi-automated test parameter worksheet 220 or automated test parameter worksheet 230) (block 414). Processor 112 copies the at least partially automatic test data (i.e. test results 224 or 234) from the test parameter worksheet (i.e. semi-automated test parameter worksheet 220 or automated test parameter worksheet 230) to the single electronic data file (test workbook 210) as copied at least partially automated test results 214 (block 416).

At block 418, processor 112 automatically combines the manual, semi-automated and automated test results by distributing the copied at least partially automated test results 214 to the test workbook 210 via a plurality of linked cells. The test parameter worksheet has several first cells that are linked to several second cells of the test workbook 210 such that the copied at least partially automatic test results 214 are mapped from the test parameter worksheet to the test workbook based on at least one cell rule. Combining the manual, semi-automated and automated test results provides the combined overall test results 218.

Processor 112 determines if the combined overall test result 218 for the process equipment 147 or field devices 146 have passed or have failed (block 420). Processor 112 indicates at least one of the cells in the test workbook 210 as having passed or failed using associated indicating indicia (block 422). Processor 112 calculates an overall test completion status 228 based on the combined overall test result 218 that have passed and that have failed (block 424). Processor 112 generates a display of the test workbook 210 (block 426) and presents the display of the test workbook 210 on video display 114 (block 428). Method 400 then ends.

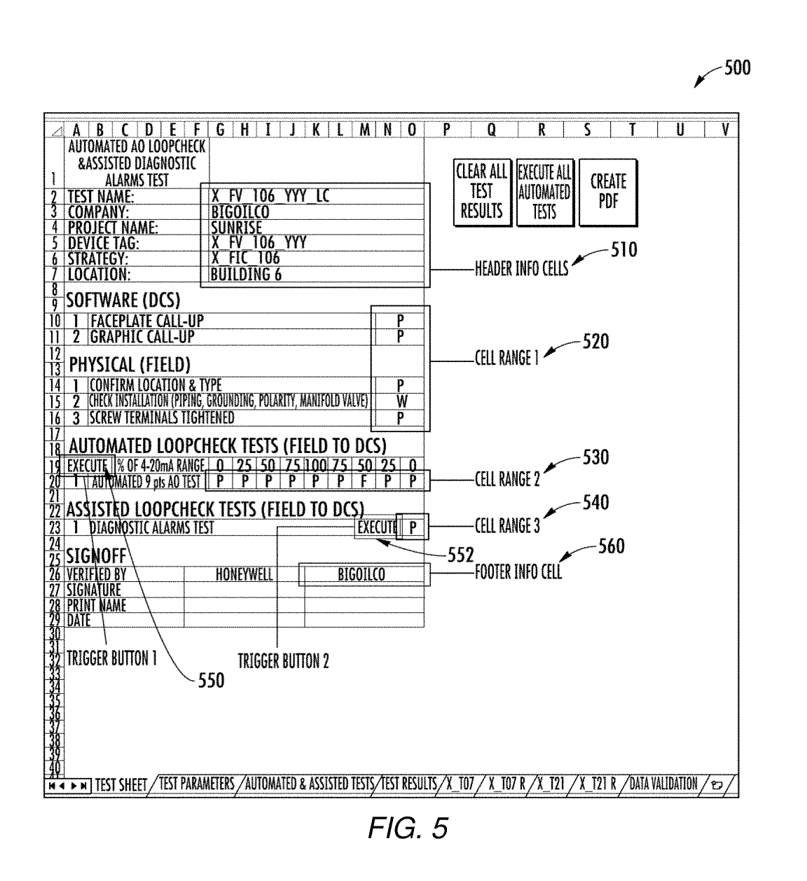

FIG. 5 is an example screenshot of a test workbook screen 500 illustrating one view of a test workbook 210. Test workbook screen 500 includes header information cells 510, manually executed test result cells 520, automated executed test result cells 530, semi-automated executed test result cells 540, trigger buttons 550 and 552 and footer information cells 560. Header information cells 510 and footer information cells 560 are mapped or linked by macros to test parameter worksheets 220 and 230 to collect and pass input values, test variables, test objects, test parameters and test results. The population of test results in the test workbook 210 is accomplished via linked cells and/or the execution of macros within the spreadsheet technology that replaces an entire worksheet including the test results. The use of linked cells and macros allows manual, semi-automated and automated test results data to be combined into a single electronic data file.

Manually executed test result cells 520 contain test results 226 that are manually entered by a user. Automated executed test result cells 530 and semi-automated executed test result cells 540 contain test results that are mapped or linked by macros to test parameter worksheets 220 and 230 to automatically collect such test results. Trigger button 550 triggers automated tests when actuated by a user and trigger button 552 triggers semi-automated tests when actuated by a user. A “P” indicia in a cell indicates a passing test while an “F” indicia in a cell indicates a failing test.

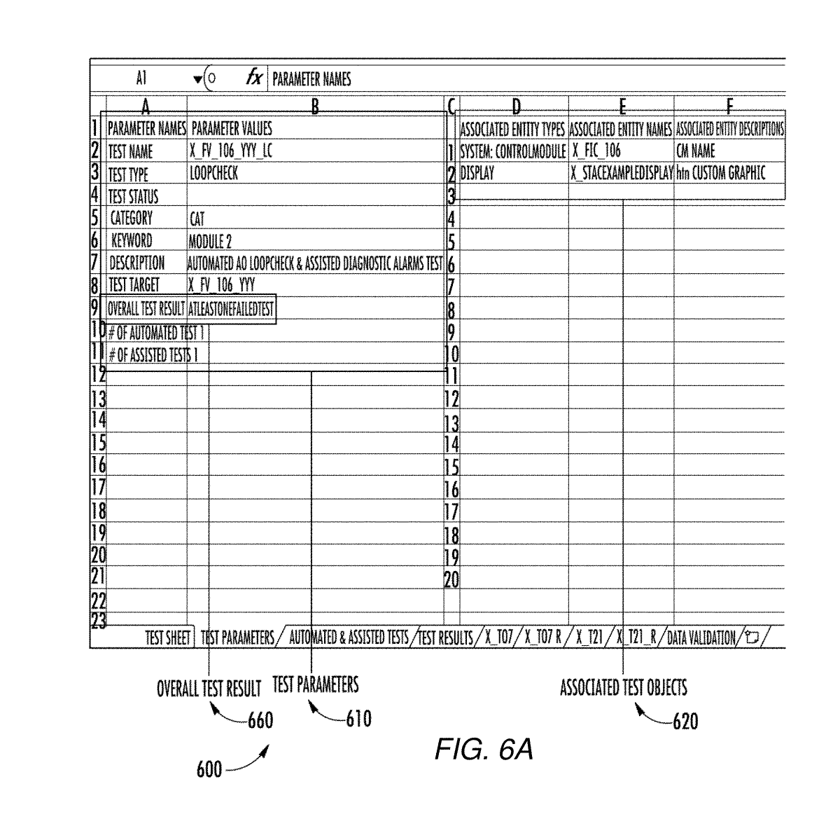

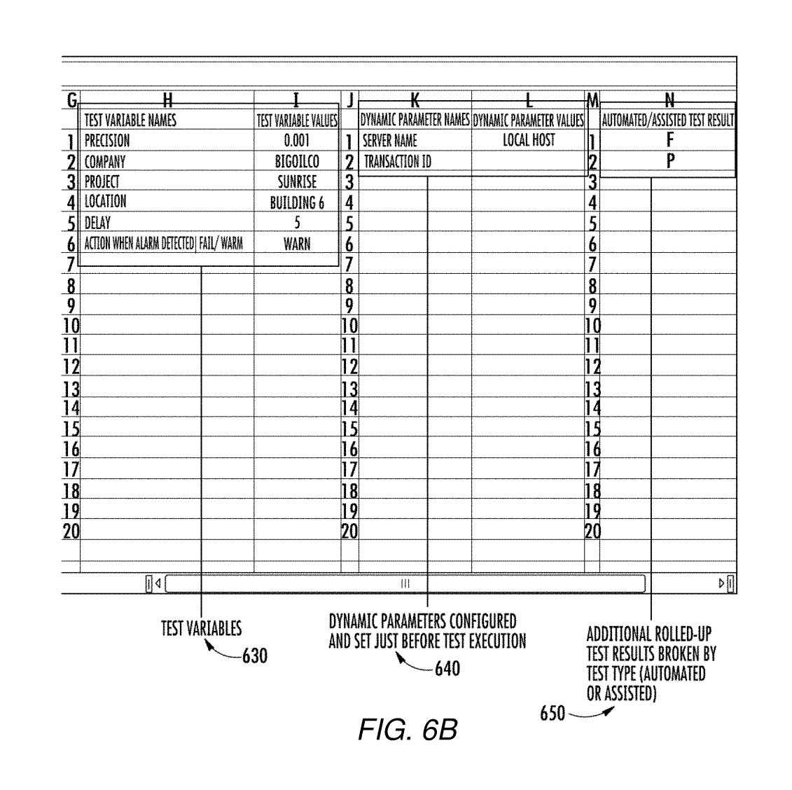

FIGS. 6A and 6B together represent an example screenshot of a test parameter worksheet screen 600 illustrating one view of a test parameter worksheet such as test parameter worksheet 220 or 230. FIG. 6A shows worksheet columns A-F, and FIG. 6B shows worksheet columns G-N. Test parameter worksheet 600 includes test parameter cells 610, associated test object cells 620, input values or test variables 630, dynamic parameters 640, additional test results 650 and overall test results 660. Test parameter cells 610, associated test object cells 620, input values or test variables 630, dynamic parameters 640, additional test results 650 and overall test results 660 that can be mapped or linked by macros to test workbook 210 and to other test parameter worksheets to collect and pass input values, test variables, test objects, test parameters and test results. Input values 630 that are entered into the test parameter worksheet are passed to the test workbook. The overall test results 660 are calculated based on the combined test results regardless whether the tests are manual, semi-automated or automated tests.

While various disclosed embodiments have been described above, it should be understood that they have been presented by way of example only, and not limitation. Numerous changes to the subject matter disclosed herein can be made in accordance with this Disclosure without departing from the spirit or scope of this Disclosure. In addition, while a particular feature may have been disclosed with respect to only one of several implementations, such feature may be combined with one or more other features of the other implementations as may be desired and advantageous for any given or particular application.

As will be appreciated by one skilled in the art, the subject matter disclosed herein may be embodied as a system, method or computer program product. Accordingly, this Disclosure can take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, this Disclosure may take the form of a computer program product embodied in any tangible medium of expression having computer usable program code embodied in the medium.

Any combination of one or more computer usable or computer-readable medium(s) may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include non-transitory media including the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CDROM), an optical storage device, or a magnetic storage device.

1. A method of combining test results from devices including processing equipment and field devices in an integrated industrial control system (IICS) of an industrial facility (IF), comprising:
entering manual test data obtained from at least a first of said devices (first device) into a first electronic data file in a memory associated with a computer-based testing tool including a processor;
said computer-based testing tool initiating at least partially automatic testing and automatic collection to obtain at least partially automatic test data involving said first device, and
automatically combining said manual test data and said at least partially automatic test data in said first electronic data file to provide a combined overall test result for said first device.

2. The method of claim 1, wherein said first electronic data file comprises a workbook comprising a plurality of worksheets.

3. The method of claim 1, wherein said first electronic data file comprises a combined data table comprising a plurality of data tables.

4. The method of claim 1, further comprising:
retrieving said first electronic data file from said memory, said first electronic data file being a single workbook comprising a plurality of worksheets associated with a first test of said devices, said worksheets including:
a first test parameter worksheet associated with said first test, said first test parameter worksheet including a plurality of test input values; and
copying said first test parameter worksheet to said workbook including said test input values.

5. The method of claim 4, further comprising:
executing said first test using at least one of said test input values for said first test;
receiving said at least partially automatic test data associated with said first test;
storing said at least partially automatic test data to said first test parameter worksheet.

6. The method of claim 5, further comprising:
distributing said at least partially automatic test data from said first test parameter worksheet to said workbook via a plurality of linked cells, said first test parameter worksheet having a plurality of first cells that are linked to a plurality of second cells of said workbook such that said at least partially automatic test data are mapped from said first test parameter worksheet to said workbook based on at least one cell rule.

7. The method of claim 1, further comprising:
retrieving said first electronic data file from said memory, said first electronic data file being a combined test table comprising a plurality of test tables associated with a first test of said devices, said combined test table including a first test table associated with said first test, said first test table including a plurality of test input values; and
copying said first test table to said combined test table including said test input values.

8. A system for combining test results from devices including processing equipment and field devices in an integrated industrial control system (IICS) of an industrial facility (IF), comprising:
an IICS computer communicatively coupled by a communication network to said devices, said IICS computer including a first processor connected to a first memory device having a first non-transitory machine-readable storage medium storing a computer-based testing tool wherein said IICS computer is programmed to implement said computer-based testing tool causing said IICS computer to:
allow entering manual test data obtained from at least a first of said devices (first device) into a first electronic data file in said first memory device;
initiate at least partially automatic testing and automatic collection to obtain at least partially automatic test data involving said first device, and
automatically combine said manual test data and said at least partially automatic test data in said first electronic data file to provide a combined overall test result for said first device.

9. The system of claim 8, wherein said first electronic data file comprises a workbook comprising a plurality of worksheets.

10. The system of claim 8, wherein said first electronic data file comprises a combined data table comprising a plurality of data tables.

11. The system of claim 8, wherein said computer-based testing tool further causes said IICS computer to:
retrieve said first electronic data file from said first memory device, said first electronic data file being a single workbook comprising a plurality of worksheets associated with a first test of said devices, said worksheets including a first test parameter worksheet associated with said first test, said first test parameter worksheet including a plurality of test input values; and
copy said first test parameter worksheet to said workbook including said test input values.

12. The system of claim 11, wherein said computer-based testing tool further causes said IICS computer to:
execute said first test using at least one of said test input values for said first test;
receive said at least partially automatic test data associated with said first test;
store said at least partially automatic test data to said first test parameter worksheet.

13. The system of claim 12, wherein said computer-based testing tool further causes said IICS computer to:
distributing said at least partially automatic test data from said first test parameter worksheet to said workbook via a plurality of linked cells, said first test parameter worksheet having a plurality of first cells that are linked to a plurality of second cells of said workbook such that said at least partially automatic test data are mapped from said first test parameter worksheet to said workbook based on at least one cell rule.

14. The system of claim 8, wherein said computer-based testing tool further causes said IICS computer to:
retrieve said first electronic data file from said first memory device, said first electronic data file being a combined test table comprising a plurality of test tables associated with a first test of said devices, said combined test table including a first test table associated with said first test, said first test table including a plurality of test input values; and
copying said first test table to said combined test table including said test input values.

15. A computer program product, comprising:
a non-transitory data storage medium that includes program instructions executable by a processor to enable said processor to execute a method of combining test results from devices including processing equipment and field devices in an integrated industrial control system (IICS) of an industrial facility (IF), said computer program product comprising:
code for entering manual test data obtained from at least a first of said devices (first device) into a first electronic data file in a memory associated with a computer-based testing tool including said processor;
code for initiating at least partially automatic testing and automatic collection to obtain at least partially automatic test data involving said first device, and
code for automatically combining said manual test data and said at least partially automatic test data in said first electronic data file to provide a combined overall test result for said first device.

16. The computer program product of claim 15, wherein said first electronic data file comprises a workbook comprising a plurality of worksheets.

17. The computer program product of claim 15, wherein said first electronic data file comprises a combined data table comprising a plurality of data tables.

18. The computer program product of claim 15, wherein said computer program product further comprises:
code for retrieving said first electronic data file from said memory, said first electronic data file being a single workbook comprising a plurality of worksheets associated with a first test of said devices, said worksheets including a first test parameter worksheet associated with said first test, said first test parameter worksheet including a plurality of test input values; and
code for copying said first test parameter worksheet to said workbook including said test input values.

19. The computer program product of claim 18, wherein said computer program product further comprises:
code for executing said first test using at least one of said test input values for said first test;
code for receiving said at least partially automatic test data associated with said first test;
code for storing said at least partially automatic test data to said first test parameter worksheet.

20. The computer program product of claim 19, wherein said computer program product further comprises:
code for distributing said at least partially automatic test data from said first test parameter worksheet to said workbook via a plurality of linked cells, said first test parameter worksheet having a plurality of first cells that are linked to a plurality of second cells of said workbook such that said at least partially automatic test data are mapped from said first test parameter worksheet to said workbook based on at least one cell rule.
